(19) United States
(12) Patent Application Publication
(10) Pub. No.: US 2008/0145736 A1
(43) Pub. Date: Jun. 19, 2008

(54) Fluid Distribution Device for Fuel Cell Power Systems

(76) Inventors: Steven D. Pratt, Yardley, PA (US); Ronald J. Kelley, Long Branch, NJ (US)

Correspondence Address: Brian M. Dingman, Esq.;Mirick, O'Connell, DeMallie & Lougee, LLP, 1700 West Park Drive, Westhorough, MA, 01581, US

(21) Appl. No.: 11/611,262

(22) Filed: Dec. 15, 2006

(51) Int. Cl. H01M 8/04

(52) U.S. Cl. 429/34

(57) ABSTRACT

A device for transferring fluid in a fuel cell power system. The device has a first barrier layer and a second barrier layer. Sealing portions bond the first and second barrier layers together in predetermined areas, to define one or more unbonded pathways between the barrier layers. The pathways are adapted to transport fluid through the device. Ports through a layer provide pathway fluid ingress and egress.

### FIELD OF THE INVENTION

The invention relates to a device for distributing liquid or gaseous fluid to one or more fuel cells. More specifically, the invention relates to a device for transferring gaseous fuel from a fuel source and distributing the fuel to and from one or more fuel cells.

### BACKGROUND OF THE INVENTION

Fuel cells are an emerging energy solution for portable products. Thin, passive, planar fuel cells open up new design possibilities owing to their thin and conformable form factor. Gaseous fuel such as hydrogen is typically used by the fuel cells. A means of providing and distributing the fuel to planar fuel cells is needed that is also thin and conformable. Such gas distribution means should preferably be lightweight, low cost, reliable and easy to manufacture. The gas distribution means should also have a high barrier (low transmission rate) to the fuel that is being transported.

Prior art fuel gas distribution systems use a network of hoses, manifolds, connectors and valves, and gas flow channels machined in plates, to deliver and distribute gaseous fuels among and within individual fuel cells and fuel cell stacks. The prior art techniques are plagued with a plethora of issues and limitations including low reliability, design complexity, leaky, and high material and assembly costs. Additionally, the prior art techniques are not suited for thin planar fuel cells in that they add unacceptable weight and thickness to the system. Prior art techniques relying on a network of connectors, manifolds, hoses and channels are also very difficult to balance properly. Tubing and hoses, for example, are limited by the fact that they typically have a constant diameter; that is, with a hose the cross-sectional flow area is fixed along the entire flow path length of the hose and cannot be varied. Finally, using flexible tubing to transfer gaseous fuel between two movable components such as through a hinge is difficult and unreliable due to the tendency of hoses to bend, kink, and impede fuel flow.

A fluid distribution device that is thin, lightweight, inexpensive, reliable and easy to manufacture, and that facilitates the transfer of fluid fuel, oxidizer and/or coolant between movable components such as through a hinge would be a welcome and beneficial addition to the fuel cell art. Additionally, it would be beneficial if the fluid distribution device flow pathways could be easily balanced.

### SUMMARY OF THE INVENTION

The invention relates to a device for distributing fluid (gaseous or liquid) fuel, oxidizer and/or coolant to and/or from one or more fuel cells. More specifically, the invention relates to such a device comprising a thin, flexible, multilayer structure incorporating one or more of the following elements:

a) internal manifolds and pathways for the transfer of one or more fluids to and from one or more fuel cells,

b) first and second barrier layers having a very low transmission rate with respect to the fluid being transferred,

c) internal, patterned sealing portions for bonding the first and second barrier layers in such a fashion as to define the internal manifolds and pathways,

d) inlet and outlet ports through the first and second barrier layers to allow for the entry and exit of fluid,

e) porous structures located within the internal manifolds and pathways to keep the flow pathways from closing off and allow for the transfer of fluid around bends and through moving elements such as a hinge,

f) separate support structures located at the inlet and outlet ports to provide structural stiffness and facilitate the attachment and sealing of external components such as fuel cells and fluid connections,

g) electrically conductive portions to provide an electrical circuit to and from fuel cells or other electronic components.

### BRIEF DESCRIPTION OF THE DRAWINGS

Referring to the drawings, wherein like features are designated with like numbering:

FIGS. 1a and 1b illustrate a first exemplary fluid distribution device in accordance with the present invention.

FIGS. 2 and 3 illustrate an exemplary fuel cell system incorporating a fluid distribution device in accordance with the present invention.

FIG. 4 illustrates an exemplary hinge assembly incorporating a fluid distribution device of the present invention.

FIG. 5 illustrates an exemplary fuel cell system incorporating a hinge assembly and a fluid distribution device of the present invention.

FIG. 6a is an exploded assembly view of an exemplary lamination fixture for creating the fluid distribution device of the invention.

FIG. 6b illustrates a fluid distribution device according to the invention made using the fixture of FIG. 6a.

### DETAILED DESCRIPTION OF PREFERRED EMBODIMENTS OF THE INVENTION

The preferred embodiments are generally described as used for distribution of gaseous fuel in a fuel cell power system. However, the invention can be used to distribute one or more fluids (gases and/or liquids) to and from one or more fuel cells of a fuel cell power system. Most commonly these fluids comprise the fuel and the oxidizer, but another fluid used in fuel cell power systems is a coolant. The invention applies to any or all of these fluids, and/or other fluids that may need to be delivered to or removed from a fuel cell.

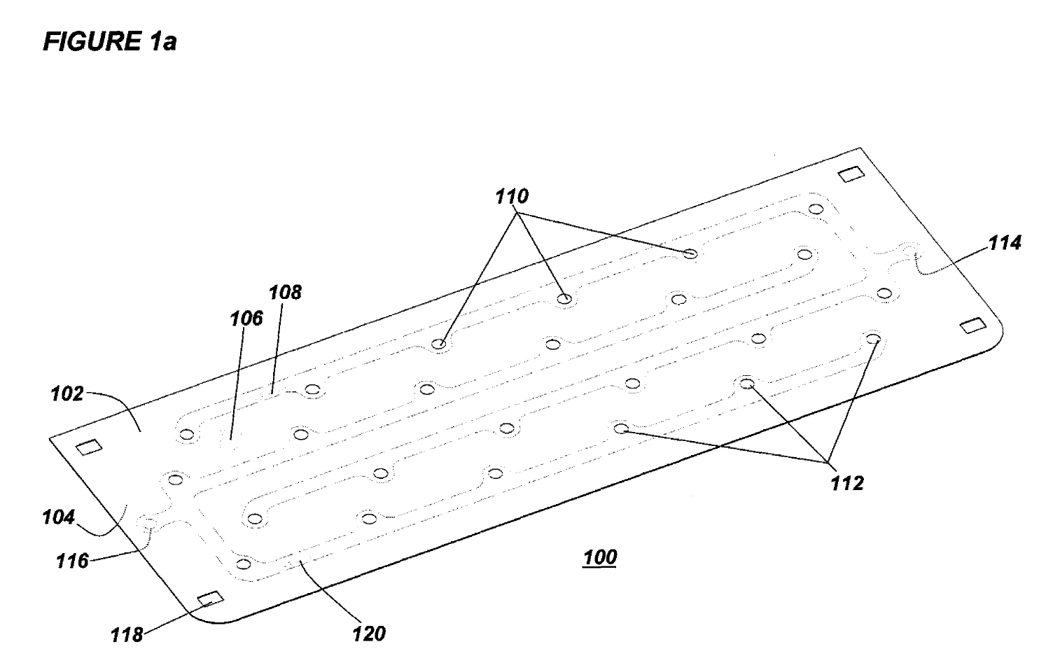

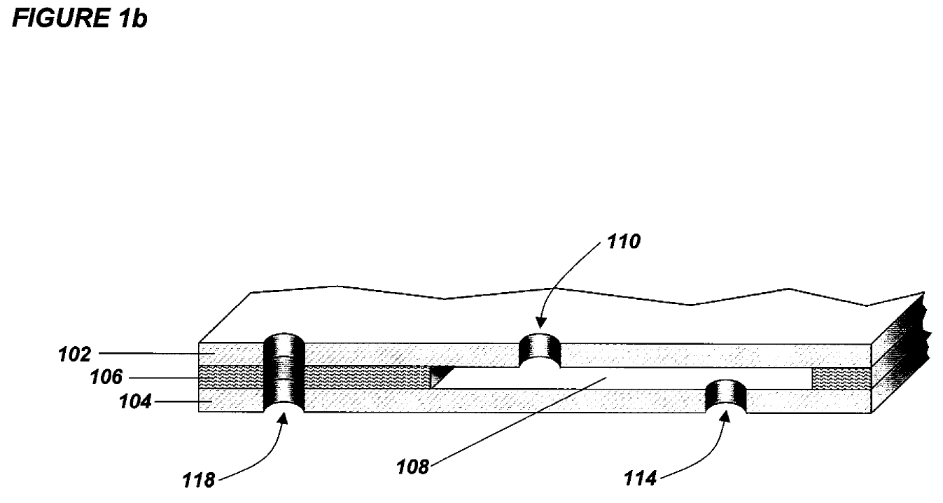

Referring to FIGS. 1a and 1b, an exemplary fluid distribution device 100 comprises a first layer 102 bonded to an opposing second layer 104 to form one or more defined internal, hollow spaces that act as fluid manifolding and distribution pathways. When the inventive device is used to transport fuel, the fuel is typically gaseous hydrogen, but may be another gas, or a liquid. When oxidant is transported, it is usually air. When coolant is transported, it is usually a liquid. The preferred embodiment will be described relative to fuel transport, with gaseous hydrogen as the fuel. FIG. 1b is a cross sectional view of fluid distribution device 100 illustrating bonded portions 106 and channel or pathway 108.

Bonded portions 106 can be formed by a bonding process that utilizes a new material that is not part of layer 102 or layer 104, such as an applied adhesive. Alternatively, bonded portions 106 can be formed by a lamination process that bonds the first layer to the second layer without requiring the addition of a new material, such as using a heat, ultrasonic or radio-frequency (RF) welding process to laminate first layer 102 to second layer 104 in a selective fashion so as to only laminate bonded portions 106. One of ordinary skill in the art of product assembly will appreciate that there are a plethora of adhesion and lamination processes that can be utilized to create the desired bonded portions 106.

Materials suitable for first layer 102 and second layer 104 include thin, flexible films that have high diffusion barrier properties with respect to the fluid being transported, which in the embodiment is gaseous hydrogen. One common measure of gas transmission through a film is the Oxygen Permeation and Transmission Rate Measurement (OTR), which can be accomplished using measurement systems such as those provided by Mocon Inc. For the purpose of the present invention, materials having suitable gas diffusion barrier properties are those having an OTR of less than about 1 cm³ per square meter of material, over 24 hours at 1 atm pressure (1 cc/m²/24 hrs/atm). Preferably, materials for the present invention will have an OTR lower than 0.1. Table 1 below lists the OTR measurements for several common barrier films for the sake of comparison.

TABLE 1

| | OTR |
|---|---|
| MATERIAL | (c.c./m²/24 hours/atm.) |
| Saran 1 mil | .8–1.1 |
| Saran HB 1 mil | 0.08 |
| Saranex 142 mil | 0.5 |
| Barex 210 1 mil | 0.7 |
| 50 M-30 PVDC Coated Polyester | 0.5 |
| Metallized Polyester 48 Ga. | .08–.14 |
| Metallized Nylon 48 Ga. | 0.05 |
| PVDC-Nylon 1 mil | 0.5 |
| 250 K Cellophane | 0.5 |
| EVAL, Biax 60 Ga. | 0.03 |
| EVAL EF-E 1 mil | 0.21 |
| EVAL EE-F 1 mil | 0.025 |

Saran and Saranex are trademarks of the Dow Chemical Company.
Barex is a trademark of BP Chemicals, Inc.
EVAL is a trademark of Kuraray Co., Ltd.

In addition to having high diffusion barrier properties with respect to the gaseous fuel and/or other fluids being transported, the flexible materials for first layer 102 and second layer 104 of the present invention must also be compatible with the bonding process that forms the bonded portions 106. For example, if a separate material such as an adhesive is used to bond the first and second layers, then the material that comprises those layers needs to be compatible with the adhesive used, and ultimately provide a bond peel strength great enough to withstand the pressure of the fuel gas flowing through the channels 108.

A preferred method of creating the bonded portions 106 is that of heat lamination, in which case the materials that make up first layer 102 and second layer 104 need to be compatible with the heat lamination process and ultimately result in bonded portions 106 having adequate bond peel strength. Bonding layer materials that are compatible with the heat lamination process include but are not limited to 100% solid polyester, polyamides, EVA's, polyethylene, and thermoplastic and reactive urethane adhesives.

Determining the needed bond peel strength is a function of the fuel gas pressure, the internal surface area and length of channels 108, and the length of bonded portions 106. For the thin planar fuel cells served by the preferred embodiment of the present invention, hydrogen gas pressure is generally low, ranging from 1 to 10 psi. As an illustrative example, a gaseous fuel distribution device 100 having a 5 inch long and ¼ inch wide channel 108 with a total surface area of 1.25 in² and a hydrogen gas flowing through at a pressure of 10 lb_{f}/in², would be subject to a resultant force of approximately 12.5 pounds trying to separate the first layer 102 from the second layer 104 along the 5 inch length of the channel. Therefore, for this example, a bond peel strength of over 2.5 pounds per inch (12.5 pounds divided by 5 inches), plus a reasonable margin of safety, would be required.

For the preferred embodiment, the material that composes first and second layers 102 and 104 is a multilayer flexible thin film structure, having both high gas diffusion barrier properties as well as the ability to be heat laminated to form channels 108. One suitable multilayer film is a laminated sandwich of 48 gauge polyethylene terephthalate (PET), 0.00035 inch thick aluminum foil, and 0.0015 inch thick linear low density polyethylene (LLDPE). This material has an OTR of 0.001 cc/m²/24 hrs/atm and is heat scalable at 400° F., 40 psi for 1 second, with resulting bond peel strength of 11 lbs. per inch. Additional preferred multilayer film materials and their relevant OTR and heat seal properties are given in Table 2 below.

TABLE 2

| | OTR | |
|---|---|---|
| | (c.c./m²/24 hours/ | HEAT SEAL |
| MATERIAL | atm.) | (processing - strength) |
| 48Ga PET/.00035 foil/LLDPE | 0.001 | 400° F./40 psi/1 sec - 11 lbs./in |
| 48Ga metalized PET/LLDPE-2.0 mil | 0.02 | 400° F./40 psi/1 sec - 11 lbs./in |
| 48Ga PET/PE/.00035 foil/LLDPE | 0.001 | 400° F./40 psi/1 sec - 11 lbs./in |
| 48ga PET/.00035 foil/metallocene PE | 0.07 | 375° F./26 psi/1 sec - 12 lbs./in |
| Aluminized PET/LDPE | 0.001 | 400° F./40 psi/1 sec - 11 lbs./in |
| Nylon/PET/.00035 foil/LLDPE | 0.01 | 425° F./40 psi/1 sec - 11 lbs./in |
| 60Ga BON (Biaxally Oriented Nylon)/.5 mil | 0.07 | 475° F./26 psi/1 sec - 12 lbs./in |
| foil/4.4 mil sealant layer | | |
| 48Ga PET/60Ga BON/.00035 foil/3.5 mils | 0.006 | 475° F./26 psi/1 sec - 12 lbs./in |
| high temperature cast polypropylene | | |

The thin, flexible, planar fluid distribution device of the invention preferably has an overall thickness of from about 0.25 to about 3 mm, and more preferably from about 0.5 to about 1.5 mm. Each layer may have a thickness in the range of from about 2 to about 20 mils, and more preferably in the range of from about 3 to about 6 mils.

First and second layers 102 and 104 further comprise one or more openings or holes 110, 112, 114 and 116 that traverse through the layer and allow access to the internal gas manifolding and gas distribution pathways 108 and 120. In FIG. 1a, hole 116, pathway 120, and at least one hole 112 collectively form an interconnected network that allows the gaseous fuel to be introduced through hole 116, transported through pathway 120 and distributed externally through holes 112. In a fuel cell system incorporating a gaseous fuel distribution device of the present invention, hole 116 would be connected to the gaseous fuel supply, and holes 112 would be referred to as “fuel inlet ports” and used to feed fuel to one or more individual fuel cells or fuel cell “stacks”.

Similarly, hole 114, pathway 108, and at least one hole 110 form an interconnected network that allows for the exhausting or purging of unconsumed fuel and byproducts from individual fuel cells through holes 110, which are referred to as “fuel outlet ports”; transporting of the unconsumed fuel and byproducts through pathway 108; and ultimately exiting of the unconsumed fuel and byproducts through hole 114. In a fuel cell system incorporating a gaseous fuel distribution device of the present invention, hole 114 would be connected to an exhaust port or fuel recapture line, as is the case in “continuous-fuel-flow” systems. In the case of a “dead-ended-fuel” system, hole 114 would be connected to a purge valve that would be momentarily opened at system start-up or other times when purging is normally desired.

The fluid distribution system 100 may also include through-holes or through-openings 118 that traverse through both the first layer 102, second layer 104, and bonded region 106. This is in contrast to holes 110, 112, 114 and 116 that individually traverse through only one layer and provide access to the internal channels 108 and 120. Through-holes 118 are designed and located to prevent fuel leaking from the channels 108 and 120, and are used for mechanical alignment and retention features in fuel cell product assembly.

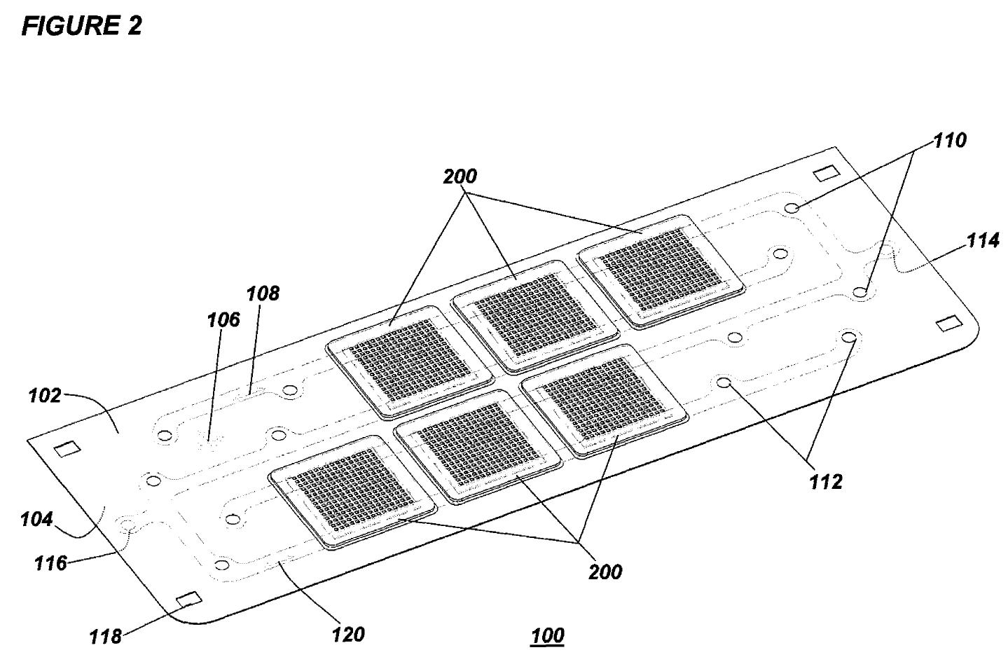

Referring now to FIG. 2, an exemplary fuel cell system is comprised of at least one unit fuel cell module 200 assembled with a gaseous fuel distribution device 100 in accordance with the present invention. The fuel cells illustrated in FIG. 2 are individual, thin, planar cells, but one skilled in the art can appreciate that the invention as disclosed herein is also suitable for use with thin planar matrix fuel cells (more than one cell electrically connected in series or parallel in a planar arrangement) as well as the traditional stack-architecture fuel cell modules.

The fuel cells 200 are assembled to the gaseous fuel distribution device 100 such that a gas-tight seal is formed between the individual filet cells and the first layer 102, and the fuel cell is preferably in communication with at least one inlet 112 and at least one outlet 110. In this way, gaseous fuel can be supplied to the fuel cells 200 through one or more fuel inlet ports 112, and unconsumed fuel and byproducts can be exhausted from the fuel cells through one or more fuel outlet ports 110 without leaking to the external environment. The gaseous fuel used in the present invention is introduced to the gaseous fuel distribution device 100 via hole 116 under low pressure, typically less than 10 lb_{f}/in². Assembly and sealing techniques for attaching the fuel cells to the top layer that can provide a gas tight seal under the low pressure conditions include, without intended limitation, adhesives, thermal bonding, encapsulation, and mechanical fastening combined with mechanical sealing such as o-rings. One of ordinary skill in the art will appreciate that there are many assembly and sealing techniques that can be employed for attaching the fluid distribution devices of the present invention to fuel cells.

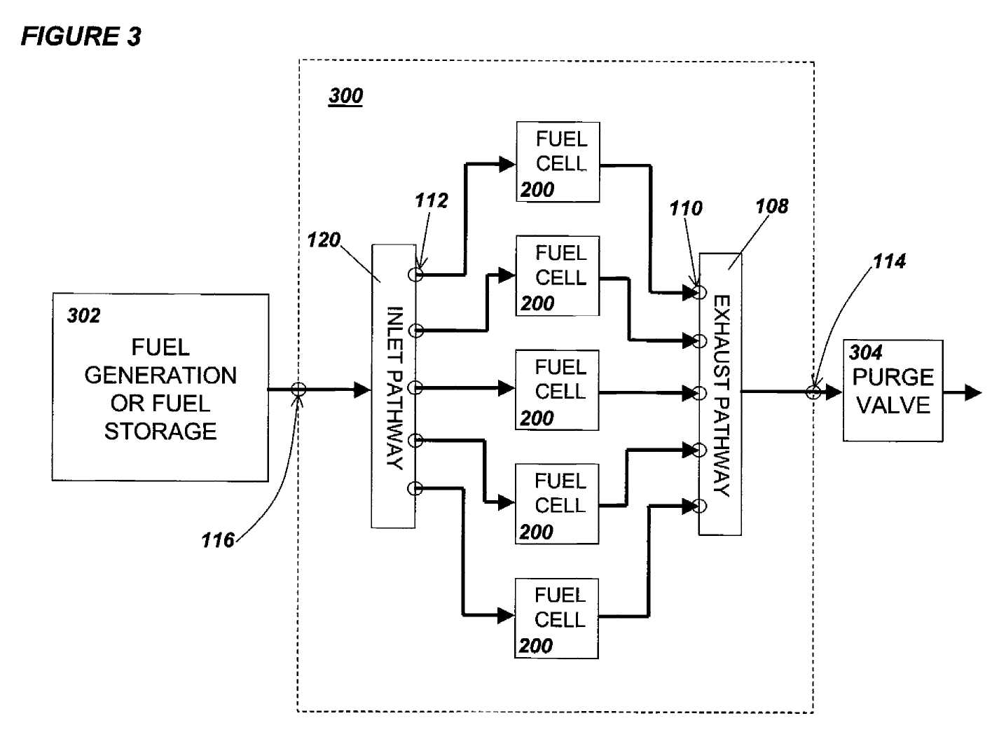

Referring to FIG. 3, a schematic representation of a fuel cell system 300 in accordance with an embodiment of the present invention is outlined showing direction of gaseous fuel flow. In FIG. 3, the gas distribution device 100 is represented by a single inlet pathway 120 and one exhaust pathway 108, along with the associated inlet hole 116 and exhaust hole 114 for clarity; fuel cell system 300 can comprise multiple fuel inlets and/or exhaust outlets, multiple interconnected collections of fuel cells, inlet ports and outlet ports, or any combination thereof.

Gaseous fuel is provided by a fuel generation or storage device 302 and supplied to the fuel cell system by way of hole 116. The gaseous fuel is transported through pathway 120 and distributed to fuel inlet ports 112 which feed individual fuel cell modules 200. Unconsumed fuel and byproducts are exhausted from the individual fuel cell modules via fuel outlet ports 110, and transported through pathway 108 to exit the fuel distribution device by way of hole 114 which is connected to purge valve 304.

For many practical applications utilizing a thin, planar fuel cell system, it is desirable to transfer one or more fluids around a bend, or between two movably connected elements such as a hinge connecting a base assembly and a cover assembly, without collapsing the fluid pathways and impeding the fluid flow. In such cases, a fluid distribution device in accordance with the present invention is preferable because of its thin and flexible nature.

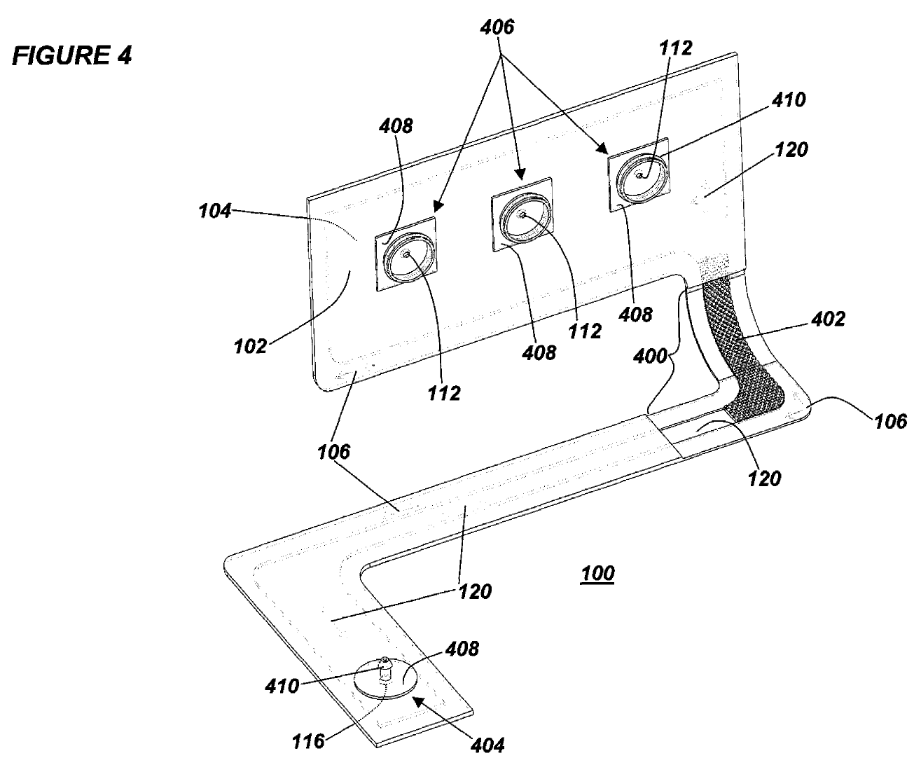

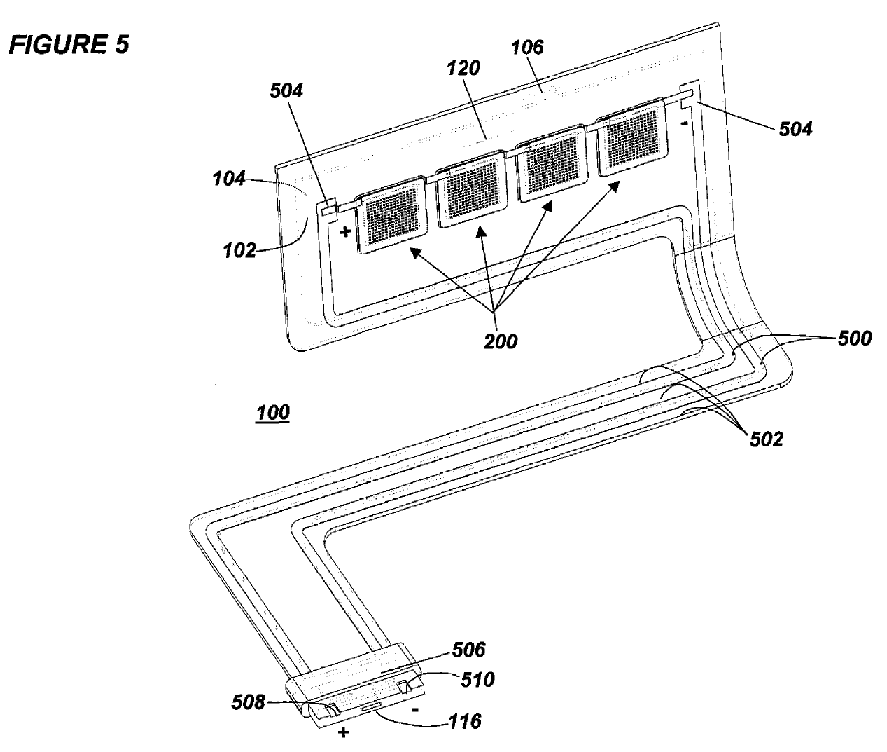

FIGS. 4 and 5 illustrate exemplary hinge assemblies incorporating fluid distribution devices of the invention. Such hinge-traversing or hinge-defining devices can be used in, for example, a notebook personal computer comprising a fuel source within the main computer body and a thin planar fuel cell located on the back of the computer display housing. In these embodiments, a gaseous fuel distribution device according to the invention is formed in a shape and dimension to fit within a notebook computer or other powered device that uses a hinge. FIG. 4 illustrates a cutaway portion 400 in which a section of first layer 102 is removed to illustrate the interior assembly including pathway 120, bonded portions 106, and a porous substrate 402. Cutaway portion 400 is provided solely for the purposes of simplifying the display and description of this embodiment; in practice, the first and second faces are continuous.

The fuel distribution device adapted for use as or with a hinge assembly further comprises one or more porous substrate components 402 positioned within at least a portion the distribution pathway 120 that passes through the binge and/or will be periodically deformed to create a bend in the fuel distribution device. The portion of the device that is deformed also obviously needs to be flexible, which is accomplished either with layers that are entirely flexible, or layers that have flexible portions that are arranged such that these flexible portions are located at the area that requires flexibility.

Materials suitable for use as porous substrate 402 include but are not limited to woven cloth, hollow filaments and open cell foam. The material choice for porous substrate 402 is selected so as to permit fluid flow while providing structural support between the first layer 102 and second layer 104, such that when the fluid distribution device is intermittently deformed, as through a hinge, the distribution pathway 120 is not allowed to collapse, kink, or otherwise shut-off and impede the flow of gaseous fuel or other fluid. This porous substrate component 402 is thin and flexible and allows easy bending and flexing of the fluid distribution device.

Also shown in FIG. 4 are optional inlet support structure 404, and optional outlet support structures 406. The support structure geometry can be as simple as a thin, stiff sheet-like structure such as Polyimide or FR-4 material that is applied via standard flex circuit adhesives or pressure sensitive adhesives to provide local stiffening for component attachment, strain relief or mounting surfaces. Alternatively, the support structure can be a more complex net-shape three-dimensional component such as injection molded or machined parts that are adhesively or otherwise bonded to the external surface of the fluid distribution device of the present invention. Support structures 404 and 406 may be injection molded parts that facilitate the connection of external devices such as, but not limited to, fuel hoses, fuel cell modules and valves to the fluid distribution device 100. The support structures have a through-hole contained therein that is aligned with a corresponding hole (i.e. 110, 112, 114 or 116) on the first surface 102. Support structures 404 and 406 also include a base portion 408 to provide structural stiffness as well as provide substantial sealing-surface area between the support structures and the first layer 102.

A device for sealing can be integrated into the support structures to facilitate a fluid tight seal between the support structure and an external fluid connection, such as a gas hose or fuel cell module. In the case of support structure 404, the device for sealing 410 is comprised of an integral hose-barb for connecting to flexible tubing. In the case of support structure 406, the device for sealing 411 is comprised of an o-ring seal that mates with a sealing surface on a fuel cell module. It can be appreciated by one of ordinary skill in the art that a variety of geometric shapes as well as numerous compressible or more rigid sealing devices can be utilized to accommodate the attachment and sealing functions without diverging from the scope and intention of the present invention.

FIG. 4 shows support structures 404 and 406 attached only to first surface 102; these support structures may alternatively be attached only to the second surface 104, or to both first and second surfaces, depending on the needs of the fuel cell system for the intended product application. Additionally, although the support structures are shown only in FIG. 4, which depicts a fuel distribution device adapted for use as or with a hinge assembly, the support structures could and most likely would also be employed in a fluid distribution device that is not adapted for use as or with a hinge assembly, for example the fluid distribution device of FIGS. 1a and 1b.

Referring now to FIG. 5, an exemplary fuel cell system incorporating a fluid distribution device of the invention adapted for use as or with a hinge assembly, includes a first surface 102 further comprising electrically conductive portions 500 and non-electrically conductive portions 502. The electrically conductive portions 500 are arranged to create an electrical circuit. The electrically conductive portions 500 also include circuit “pads” 504 that provide a means of electrical interconnection to fuel cell array 200, and/or to other electronic components needed (not shown in the drawing), including but not limited to sensors and control circuitry.

In a preferred embodiment, first surface 102 and electrically conductive portions 500 collectively are traditionally referred to as a flexible circuit (or flexible printed wiring). Flexible circuits are most commonly manufactured using one of two base materials, either polyimide or polyester, but can also be made using alternative materials such as liquid crystal polymer (LCP). Flexible circuits can be made single sided, double sided and multilayer, referring to the number of conductive layers. Although copper foil is the most common metal foil that can be used as the conductor in a flexible circuit, alternative conductors can be employed including but not limited to copper alloys, nickel, kovar, steel and resistance alloys, and electrically conductive inks. In the preferred embodiment, the flexible circuit is a multilayer construction consisting of a polyimide substrate having electrically conductive portions 500 patterned on one surface from 316L stainless steel foil, with an inner layer of the multilayer construction being a continuous sheet of 316L stainless steel foil as a barrier layer.

A fluid distribution device 100 employing a first surface 102 having electrically conductive portions 500 may further include electromechanical connector 506 for interfacing the fluid distribution device and fuel cell array to external devices such as a fuel supply and a host device to be powered by the fuel cell array. Connector 506 includes fuel inlet hole 116 to allow fuel into inlet pathway 120. Connector 506 also includes electrical terminals 508 and 510. In FIG. 5, electrical terminal 508 is electrically connected to the cathode end of fuel cell array 200 by way of conductive electrical circuit 500 and pad 504, and is referred to as the positive terminal. Likewise, electrical terminal 510 is electrically connected to the anode end of fuel cell array 200 and is referred to as the negative terminal. Additional electrical terminals could be added as needed to provide electrical communication with other electronic components such as sensors and control circuitry. Electromechanical connector 506 provides a similar mechanical support function as inlet and outlet support structures 404 and 406 from FIG. 4, with the added functionality of providing electrical interconnection via electrical terminals 508 and 510. Additionally, although electrically conductive portions 500, circuit pads 504 and electromechanical connector 506 are shown only in FIG. 5, which includes a fluid distribution device adapted for use as or with a hinge assembly, the invention is not so limited and electrically conductive portions 500, circuit pads 504 and/or connector 506 could also be used in a fluid distribution device of the invention that is not adapted for use as or with a hinge assembly.

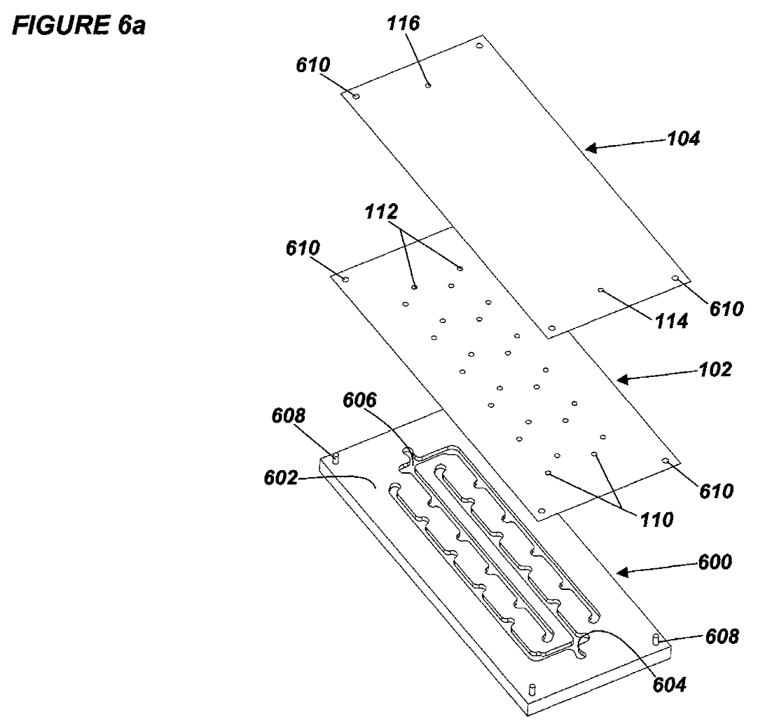

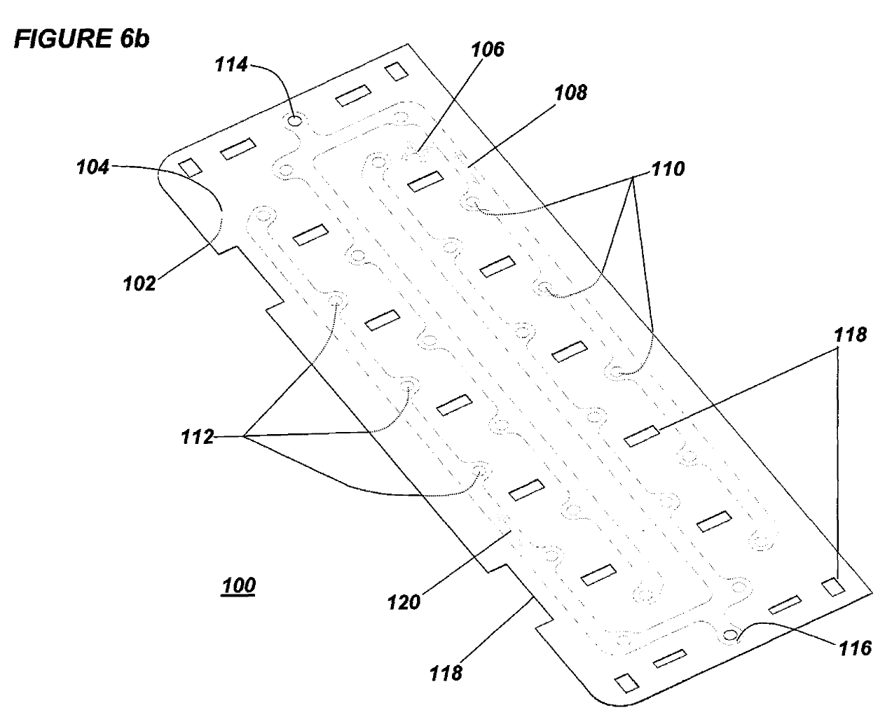

Referring now to FIGS. 6a and 6b, an exemplary lamination assembly for creating a fluid distribution device of the invention includes first layer 102, second layer 104, and lamination die 600. Lamination die 600 further comprises alignment pins 608, raised portions 602, and depressed portions 604 and 606. First layer 102 and second layer 104 include alignment holes 610 which provide alignment of the layers with respect to the alignment pins 608.

A preferred method of creating the fluid distribution device of the present invention involves die cutting first layer 102 and second layer 104 out of multilayer film material to proper shape and size, including die cutting holes 110, 112, 114, 116 and 610. The layers are then aligned and mated to heated lamination die 600 via alignment pins 608. Fluid distribution device 100 is then fabricated by applying heat and pressure to selectively bond first layer 102 to second layer 104, melting the adhesive or the adjacent inner surfaces to form bonded portions 106 that correspond to raised portions 602 on the heated lamination die 600. Unbonded portions (channels 108 and 120) correspond to depressed portions 606 and 604 on the heated lamination die 600. After lamination for the proper amount of time, usually a few seconds or less, the heated lamination die is removed and the now laminated assembly is die cut to the final shape, including through holes or through openings 118.

Temperature and pressure needed for proper lamination (heat sealing) of first layer 102 to second layer 104 depend on the materials used. Table 2 lists some preferred multilayer materials including the recommended heat seal temperatures, pressures and times. Care must be taken not to overheat, over compress or otherwise laminate the materials for too long to avoid the melted material from flowing into the unbonded channel portions 108 and 120, thus blocking the channels and defeating the intended function of the channels to transport and distribute gaseous fuel.

In a specific preferred embodiment, a fluid distribution device of the present invention was fabricated from a multilayer film of 48 gauge polyethylene terephthalate (PET), 0.00035 inch thick aluminum foil, and linear low density polyethylene (LLDPE) that acts as the bonding layer. First layer 102 and second layer 104 component blanks, including alignment holes 610, were cut from the film using a steel-ruled die. The blanks were then each placed into an associated punch press fixture (aligned using the alignment holes 610) that created holes 110, 112, 114 and 116. First layer 102 and second layer 104 were then aligned and assembled onto a jig in an arbor press device and mated such that the heat seal material (LLDPE) of first layer 102 was mated to the heat seal material of second layer 104. The base of the jig was a thermal insulator (silicone rubber pad). Lamination die 600, assembled in the arbor press and heated to 400° F., was lowered and pressed against the multilayer assembly for one second at a pressure of 40 psi (480 pounds force divided by 12 in² surface area of the die). After lamination, the first and second layer assembly was aligned and placed in a final trimming fixture which cut the fluid distribution component to shape and created through holes 118.

Although lamination die 600 is shown as a single die that accomplishes the lamination process by applying heat and pressure to only one side of the assembly including first layer 102 and second layer 104, it would be apparent to one of ordinary skill in the art that the lamination could also accomplished using two mating lamination dies, each having raised portions 602 and depressed portions 604 and 606 that are mirror images; that is, the pattern on one die is mirrored on the other die. Additionally, although the lamination die 600 is shown as a planar geometry and first layer 102 and second layer 104 are shown as single sheets, which are applicable for batch processes, the lamination process could be accomplished in a continuous, roll-to-roll fashion using heated, patterned rotating cylinders as lamination dies and feeding a contiguous sheet of layers 102 and 104 through the rotating dies. This continuous process would be more desirable if a large quantity (for example, 100,000 or more) of identical fluid distribution devices were needed. Thus, it can be seen that the fluid distribution device of the present invention lends itself to automated, high volume manufacturing processes. This is in contrast to the prior art method of fluid distribution in fuel cell power systems that relies on an array of hoses and mechanical connectors or a multi-part rigid manifold, the assembly of which is complex and labor intensive.

By proper design of the lamination die, or proper placement of the adhesive, the invention allows a variation in the geometry of the pathways/channels (e.g., their cross sectional area along their length) to achieve a desired result, for example to “balance” the fluid pressures and flows throughout the fuel cell system. As opposed to a hose, which normally has a continuous cross-section (e.g., a ⅛″ diameter circle), this invention allows the creation of channels of variable width, shape, length, etc.

Although specific features of the invention are shown in some figures and not others, this is for convenience only, as some features may be combined with any or all of the other features in accordance with the invention.

Recitation of ranges of values herein are merely intended to serve as a shorthand method of referring individually to each separate value falling within the range, unless otherwise indicated herein, and each separate value is incorporated into the specification as if it were individually recited herein.

The use of any and all examples, or exemplary language (e.g., “such as”) provided herein, is intended merely to better illustrate the invention and does not pose a limitation on the scope of the invention.

A variety of modifications to the embodiments described herein will be apparent to those skilled in the art from the disclosure provided herein. Thus, the invention may be embodied in other specific forms without departing from the spirit or essential attributes thereof.

What is claimed is:

1. A device for transferring a fluid in a fuel cell power system, comprising:
a first at least partially flexible barrier layer;
a second at least partially flexible barrier layer;
sealing portions that bond the first and second barrier layers together in predetermined areas, to define one or more unbonded fluid pathways between the barrier layers; and
one or more ports providing fluid access to a pathway.

2. The device of claim 1 wherein the sealing portions are formed by laminating the barrier layers together.

3. The device of claim 1 wherein the sealing portions comprise an adhesive located between the barrier layers.

4. The device of claim 1 wherein essentially all of the first barrier layer is flexible.

5. The device of claim 4 wherein essentially all of the second barrier layer is flexible.

6. The device of claim 1 further comprising a porous structure in a pathway to inhibit the pathway from collapsing.

7. The device of claim 1 further comprising an electrically-conductive circuit.

8. The device of claim 7 wherein the electrically-conductive circuit is an integral part of at least one barrier layer.

9. The device of claim 7 wherein the electrically-conductive circuit is on the outside of at least one barrier layer.

10. The device of claim 1 wherein the one or more ports comprises at least one inlet port passing through one of the barrier layers and communicating with a pathway.

11. The device of claim 10 wherein the inlet port comprises a support structure coupled to a barrier layer.

12. The device of claim 10 wherein the inlet port further comprises a device for accomplishing a fluid-tight seal.

13. The device of claim 12 wherein the device for accomplishing a fluid-tight seal comprises a compressible member.

14. The device of claim 12 wherein the device for accomplishing a fluid-tight seal comprises an o-ring.

15. The device of claim 12 wherein the device for accomplishing a fluid-tight seal comprises a hose barb.

16. The device of claim 1 wherein the one or more ports comprises at least one outlet port passing through one of the barrier layers and communicating with a pathway.

17. The device of claim 16 wherein the outlet port comprises a support structure coupled to a barrier layer.

18. The device of claim 16 wherein the outlet port further comprises a device for accomplishing a fluid-tight seal.

19. The device of claim 18 wherein the device for accomplishing a fluid-tight seal comprises a compressible member.

20. The device of claim 18 wherein the device for accomplishing a fluid-tight seal comprises an o-ring.

21. The device of claim 18 wherein the device for accomplishing a fluid-tight seal comprises a hose barb.

22. The device of claim 1 wherein at least one barrier layer comprises a multilayer structure.

23. The device of claim 22 wherein the multilayer structure comprises a plastic inner layer.

24. The device of claim 22 wherein the multilayer structure comprises spaced metal foil layers.

25. The device of claim 1 wherein the first and second barrier layers are generally planar.

26. The device of claim 25 wherein flexible portions of the two barrier layers are adjacent, so that the device is adapted to bend at the location of the adjacent flexible portions.

27. The device of claim 26 wherein the adjacent flexible portions define a hinge.

28. The device of claim 27 wherein a pathway passes through the hinge, and the device further comprises a porous structure located in the pathway in the hinge.

29. A device for transferring a fluid in a fuel cell power system, comprising:
a first at least partially flexible barrier layer;
a second at least partially flexible barrier layer;
sealing portions that bond the first and second barrier layers together in predetermined areas, to define one or more unbonded fluid pathways between the barrier layers;
wherein flexible portions of the two barrier layers are adjacent and define a hinge, so that the device is adapted to bend at the location of the hinge, and wherein a pathway passes through the hinge;
a porous structure located in the pathway in the hinge to inhibit the pathway from collapsing as the hinge is bent; and
one or more ports providing fluid access to a pathway.

30. A device for transferring a fluid in a fuel cell power system, comprising:
a first multilayer flexible barrier layer;
a second flexible multilayer barrier layer;
sealing portions that bond the first and second barrier layers together in predetermined areas, to define at least two unbonded fluid pathways between the barrier layers;
wherein adjacent portions of the two barrier layers define a hinge, so that the device is adapted to bend at the location of the hinge, and wherein a pathway passes through the hinge;
a porous structure located in the pathway in the hinge to inhibit the pathway from collapsing as the hinge is bent;
one or more inlet ports passing through one of the barrier layers and communicating with a pathway, and comprising a device for accomplishing a fluid-tight seal; and
one or more outlet ports passing through the other of the barrier layers and communicating with a different pathway, and comprising a device for accomplishing a fluid-tight seal.
